(19) United States
(12) Patent Application Publication
(10) Pub. No.: US 2004/0024596 A1
(43) Pub. Date: Feb. 5, 2004

(54) Noise reduction system

(76) Inventors: Laurel H. Carney, Syracuse, NY (US); Michael C. Anzalone, Syracuse, NY (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 10/631,286

(22) Filed: Jul. 31, 2003

Related U.S. Application Data
(60) Provisional application No. 60/400,357, filed on Jul. 31, 2002.

(51) Int. Cl. G10L 19/10

(52) U.S. Cl. 704/220

(57) ABSTRACT

A system for reducing noise in a wideband signal, such as speech, using a first filterbank and running cross-correlator to detect narrowband frequency components in the signal and an analysis-synthesis filterbank to attenuate the wideband signal in which narrowband frequency components are not detected. The narrowband frequency components are detected by performing a running cross-correlation of the outputs of two bandpass filters that have center frequencies that straddle the narrowband frequency and differ by 180 degrees relative to each other at the frequency to be detected. Relatively low value cross-correlations indicate that a signal is present in a given frequency band and high value cross-correlations indicate only noise is present. The wideband signal is processed by an analysis-synthesis filterbank to attenuate bands where narrowband frequency components have not been detected and to pass or amplify bands where narrowband frequency components have been detected.

### CROSS-REFERENCE TO RELATED APPLICATIONS

The present application claims priority to U.S. Provisional Application Serial No. 60/400,357, filed Jul. 31, 2002, entitled “A Noise Reduction System for Use in Audio Communications Systems,” hereby incorporated by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant No. R01 01640 awarded by National Institutes of Health—National Institute on Deafness and Other Communication Disorders.

### BACKGROUND OF THE INVENTION

1. Field of Invention

The present invention relates to the reduction of noise in signals and, more particularly, to a system and method for reducing noise in a wideband signal with fluctuating amplitude.

2. Description of Prior Art

Traditional noise reduction systems use filters, such as the Wiener filter, to remove undesirable noise from signals. Systems such as this depend on prior knowledge of the properties of the noise, however, and are ineffective when the noise varies or is indeterminate. These systems depend on stationarity in the noise to perform optimally and are less effective when the noise has fluctuation in amplitude.

Some systems, such as the Kalman filter, depend on a running estimate of the properties of the noise and use a time-varying filter to optimize the signal-to-noise (SNR) ratio. These systems, however, require sophisticated modeling of the noise and complex algorithms.

Other noise reduction systems use spectral subtraction, which involves an estimation of the magnitude spectrum of the background noise and then a subtraction from the magnitude spectrum of the contaminated signal. The background noise is usually estimated during noise-only sections of the signal. Such an approach can remove background noise but the remaining signal tends to have artifacts that are the result of isolated spectral components that are not completely removed during the subtraction process. Spectral subtraction also requires an estimate of the noise spectrum during a noise-only portion of the signal and its performance is therefore dependent on the static nature of the noise over time.

3. Objects and Advantages

It is a principal object and advantage of the present invention to provide a system and method for reducing noise in a wideband signal, such as speech, having fluctuating characteristics, such as amplitude.

It is an additional object and advantage of the present invention to provide a system and method for reducing noise that does not require knowledge of the properties of the noise.

It is a further object and advantage of the present invention to provide a system and method for reducing noise that does not require knowledge of the properties of the signal.

Other objects and advantages of the present invention will in part be obvious, and in part appear hereinafter.

### SUMMARY OF THE INVENTION

The present invention comprises a system for reducing noise in a wideband signal using a bank of signal detectors that sets the gains for a second bank of filters that attenuate noise. Frequency bands in which a signal is detected are preserved or amplified while frequency bands in which no signal is detected are attenuated. Signal detection is accomplished by a detection system comprising a series of bandpass filters, followed by saturating non-linearities and running cross-correlators that cross-compare pairs of filters in the filterbank that are 180-degrees out of phase with each other at predetermined frequencies. The frequency resolution of the detection process is determined by the distribution of these detectors along the frequency axis.

The results of the running cross-correlation determine which frequency bands receive attenuation and which do not. Relatively low value cross-correlations indicate that a non-noise signal is present in a given frequency band and high value cross-correlations indicate that only noise is present. Using these results, the wideband signal is filtered by a second filterbank having gains set to a high value when the cross-correlator returns a low value, and gains that are set to a low value when the cross-correlator returns a high value. The outputs from the second filter banks are then used to synthesize the noise-reduced signal.

### BRIEF DESCRIPTION OF THE DRAWINGS

FIG. 1 is a schematic of a noise reduction system according to the present invention.

FIG. 2 is a schematic of the signal detectors according to the present invention.

FIG. 3 is a graph of the magnitudes and phases of the transfer functions of two filters selected according to the present invention to determine whether a 900-Hz frequency signal is presence in the wideband input.

### DETAILED DESCRIPTION

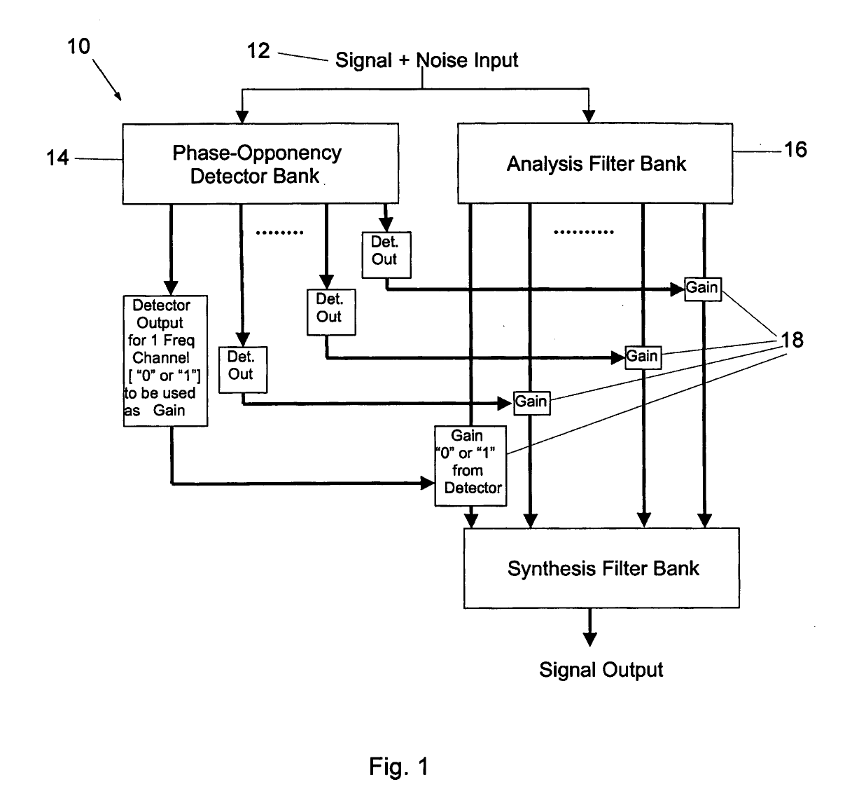

Referring now to the Figures, wherein like numerals refer to like parts are throughout, there is seen in FIG. 1 a high-level illustration of a system 10 for reducing noise of indeterminate characteristics from a wideband audio signal input 12, such as speech. Wideband signal 12 is input to a bank of phase-opponency detectors 14. One phase-opponency detector 14 is required for each desired frequency channel in system 10. The time-varying output of each detector 14 sets the gain 18 in the corresponding frequency channel of the analysis-synthesis filterbank 16. Any “perfect reconstruction filterbank” algorithm can be used for the analysis-synthesis filterbank 16.

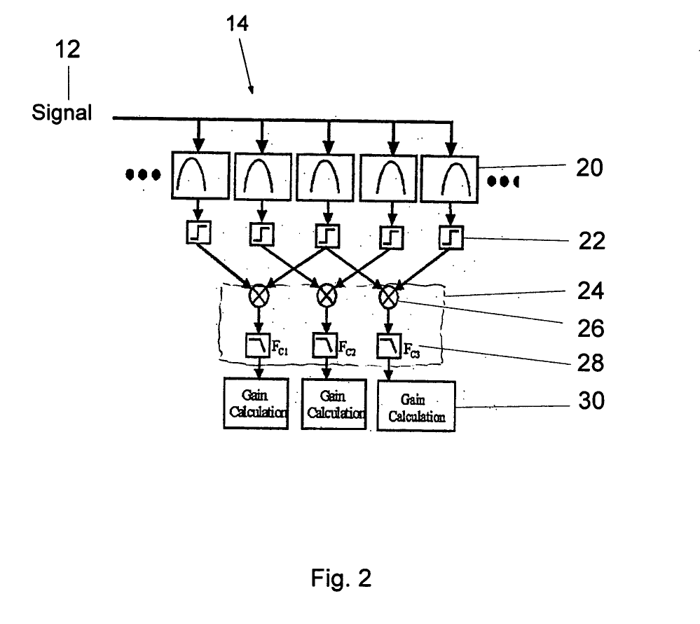

As seen in more detail in FIG. 2, phase-opponency detectors 14 comprise a filterbank 20 into which signal 12 is input. Although filterbank 20 is depicted as a linear gammatone filterbank, any bandpass filters may be used for filterbank 20. The bandwidth of the filters in filterbank 20 can be varied or held constant as a function of frequency.

The spacing of the frequencies of the filters in filterbank 20 is chosen to create “phase opponency;” i.e., the frequencies are selected so that predetermined pairs of filters are 180-degree out of phase with each other at a predetermined narrowband frequency, referred to as the phase-opponency frequency. The numbers of filters used in filterbank 20, and the spacing between them, determine the frequency resolution of system 10.

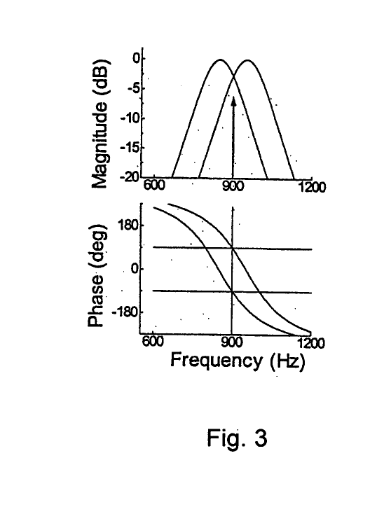

The magnitudes and phases of the transfer functions of the two filters used to detect, for example, a 900-Hz signal are illustrated in FIG. 3. The filter frequencies can be derived analytically for a given filter transfer function and are selected to be above and below the phase-opponency frequency by a predetermined amount while differing by 180 degrees at the phase-opponency frequency. For example, the use of between 30 to 60 filters in filterbank 20, where each successive filter is 90-degrees out of phase, support a sufficient number of phase-opponency frequencies to filter noise from an average wideband audio signal.

The outputs from filterbank 20 are followed by a saturating non-linearity component 22 which removes the effects of input amplitude and allows the detection stage to rely solely on temporal information rather than magnitude. Saturating non-linearity component 22 creates a signal output that goes no higher than +1 and no lower than −1. For any positive value on the input, the output is set to +1 and for any negative input, the output is −1. Thus, after saturating nonlinearity component 22, the signal is dominated by +1, −1 and the zero crossings, and is no longer affected by changes in the signal energy. As a result of saturating non-linearity component 22, the timing of the zero crossings is determined by positive and negative fluctuations in the input and the frequency and phase information is all that passes. Saturating non-linearity component 22 can be accomplished by a simple circuit, such as a very high-gain amplifier followed by a pair of limiters (e.g. a diode circuit), or by software programmed with a signum function.

The saturated outputs of filterbank 20 are then subject to a running cross-correlation 24, which indicates the presence of a narrowband signal near the phase-opponency frequency by a decrease in the results of running cross-correlation 24. Running cross-correlation 24 begins by comparing pairs of the saturated non-linearity component 22 outputs of filterbank 20 with cross-correlators 26 to measure the correlation of the cross-compared outputs as a function of time. Cross-correlator 26 can comprise a programmed software function, a multiplier, or modulator circuit designed from transistor circuitry.

The second stage of running cross-correlation 24 involves passing the output of the cross-correlators 26 through a series of low-pass filters 28 having a cut-off frequency that sets the integration time of running cross-correlator 24. Low-pass filters 28 smooth the output of cross-correlator 26 over time. The outputs of low-pass filters 28 at any one point in time depend on recent history (based on the comer frequency of low-pass filters 28), as opposed to only on the input at that moment.

In the presence of wideband noise only, the responses of the two filters whose output is subject to running cross-correlation 24 will be partially correlated, due to the frequency overlap in each pair of filters 20. In response to a wideband signal that contains a narrowband signal at the phase-opponency frequency, the filters are drawn out-of-phase, resulting in a reduced response in the appropriate frequency channel of running cross-correlator 24. Thus, detection of a narrowband signal(s) amidst wideband noise is determined when the output(s) of low-pass filter(s) 28 drops below a predetermined threshold.

The time window of running cross-correlation 24 can vary with the center frequencies of particular filters in filterbank 20 that are cross-compared, such that lower frequency filter pairs perform the cross-correlation over a longer time than higher frequency pairs. The window size (or low-pass cutoff frequency 28) of running cross-correlator 24 determines the response time of system 10 and may be adjusted based on the dynamics of the signals of interest.

The frequency detection results from running cross-correlators 24 are used to calculate the gains 18 for use in the analysis-synthesis filterbank 16. As the presence of narrowband signals results in reduced responses of cross-correlators 24 that are comparing the phase opponent filters, gains 18 are set to a high value, e.g., one (1), when corresponding cross-correlators 24 return a low value, gains 18 are set to a low value, e.g., zero (0). As seen in FIG. 1, gains 18 are used by the analysis-synthesis filter bank 16 to control which frequency bands are attenuated and which are either allowed to pass or amplified.

Analysis-synthesis filterbank 16 selectively attenuates noise components in wideband signal input 12, while preserving narrowband frequency components independently of any amplitude information in the input 12. As a result, system 10 can reduce noise in a wideband signal that has fluctuating amplitude without any resulting loss in effectiveness.

What is claimed is:

1. A system for reducing noise in a wideband signal having at least one narrow frequency component comprising:
a filterbank comprising a first filter having a first frequency and a first output and a second filter having a second frequency and a second output, wherein the phases of said first frequency and said second frequency differ by 180 degrees about a third frequency;
a running cross-correlator interconnected to said first filterbank for comparing said first output of said first filter and said second output of said second filter; and
an analysis-synthesis filterbank for attenuating said wideband signal at said third frequency in response to said running cross-correlator.

2. The system of claim 1, further comprising first and second saturating non-linearity components interconnecting said first filter and said second filter, respectively, to said running cross-correlator.

3. The system of claim 2, wherein said first and second saturated non-linearity components are signum functions.

4. The system of claim 1, wherein said running cross-correlator comprises a cross-correlator interconnected to a low-pass filter.

5. The system of claim 1, wherein said second filterbank attentutes said third frequency only when said running cross-correlator has a reduced response.

6. A method for reducing noise in a wideband signal, comprising the steps of:
(a) filtering said wideband noise at a first frequency to produce a first filter output;
(b) filtering said wideband noise at a second frequency to produce a second filter output, wherein the phases of said first frequency and said second frequency differ by 180 degrees about an intermediate third frequency;
(c) performing a running cross-correlation of said first filter output and said second filter output; and
(d) attenuating said wideband signal at said third frequency according to said running cross-correlation.

7. The method of claim 6, further comprising the step of transforming said first filter output and said second filter output with a saturated non-linearity component function prior to performing said running cross-correlation.

8. The method of claim 6, further comprising the step of amplifying said wideband signal at said third frequency if said running cross-correlation has a low value.

9. The method of claim 6, further comprising the steps of
(a) filtering said wideband noise at a fourth frequency to produce a fourth filter output;
(b) filtering said wideband noise at a fifth frequency to produce a fifth filter output, wherein the phases of said fourth frequency and said fifth frequency differ by 180 degrees at an intermediate sixth frequency;
(c) performing a running cross-correlation of said saturated fourth filter output and said saturated fifth filter output; and
(d) attenuating said wideband signal at said sixth frequency according to said running cross-correlation.

10. The method of claim 9, further comprising the step of combining the attenuated signals of steps (d) and (j).

11. The method of claim 6, wherein the step of attenuating said wideband signal at said third frequency according to said running cross-correlation comprises passing said wideband signal through an analysis-synthesis filterbank.
